(19) United States
(12) Patent Application Publication
(10) Pub. No.: US 2017/0062167 A1
(43) Pub. Date: Mar. 2, 2017

(54) Protective Device

(71) Applicant: LITTEFLUSE JAPAN G.K., Kawasaki-shi (JP)

(72) Inventors: Arata Tanaka, Ryugasaki-shi (JP); Hirosuke Uchino, Narita-shi (JP); Hirofumi Grey Mochizuki, Ushiku-shi (JP)

(73) Assignee: Tyco Electronics Japan G.K., Kawasaki-shi (JP)

(21) Appl. No.: 14/913,846

(22) PCT Filed: Aug. 18, 2014
(86) PCT No.: PCT/JP2014/071567

§ 371 Date: Oct. 18, 2016

(30) Foreign Application Priority Data
Aug. 26, 2013 (JP) 2013-174546

(51) Int. Cl. H01H 71/16

(52) U.S. Cl. CPC H01H 71/16

(57) ABSTRACT

The present invention relates to a protection device comprising a resin base, a first terminal, a PTC component, a bimetal component, an arm, an upper plate and a resin cover wherein flexibility of connecting to a lead or other electrical elements is high and sensitivity to the abnormal heat generation occurring outside is high. The protection device of the present invention comprises a resin base, a first terminal, a PTC component, a bimetal component, an arm, an upper plate and a resin cover; and the first terminal, the PTC component, the bimetal component, the arm and the upper plate are superposed in the above-mentioned order within a resin housing defined by the resin base and the resin cover, the portion of the upper plate is exposed at the portion of the resin cover, and the exposed portion functions as a second terminal, the first terminal, the arm and the upper plate are electrically connected in series in the above-mentioned order, and in an abnormal state where the bimetal component is activated, the first terminal and the arm become to be electrically cut off while the first terminal, the PTC component, the bimetal component, the arm and the upper plate become to be electrically connected in series in the above-mentioned order.

### TECHNICAL FIELD

The present invention relates to a protection device comprising a bimetal component and a PTC (positive temperature coefficient) component.

### BACKGROUND ART

When an abnormality occurs in an electrical apparatus, for example, when a current excessively flows through the electrical apparatus (for example, a motor) and thereby causes the electrical apparatus to reach an abnormally high temperature or when the electrical apparatus reaches an abnormally high temperature due to some reason other than the excessive current, it is needed to secure a safety of the electrical apparatus by interrupting the current flowing through the electrical apparatus, and then eliminating the cause of the abnormality if necessary. A bimetal component is used as a means to interrupt the current as described above.

The bimetal component comprises a sheet member of a bimetal metal. The bimetal component is configured to activate (i.e. deform) so as to interrupt a current flowing through the bimetal component when the bimetal component itself reaches a higher temperature in excess of a predetermined temperature, or when the bimetal component reaches a higher temperature in excess of a predetermined temperature due to a rise in the temperature of an ambient atmosphere of the bimetal component.

When such a bimetal component is incorporated in an electrical apparatus, the bimetal component activates when the electrical apparatus reaches an abnormal temperature due to an excessive current or some other reason, so that the current is interrupted. The temperature of the electrical apparatus is lowered by the interruption of the current. Since the temperature of the bimetal component itself is also lowered, the bimetal component returns to its original shape (i.e. it recovers), as a result of which the current may be allowed to flow again before eliminating the cause of the abnormality and securing the safety of the electrical apparatus.

In order to prevent the current from flowing again as described above, it is necessary to ensure and maintain a state where the bimetal is activating. For this purpose, the bimetal component is disposed in series with respect to a circuit of the electrical apparatus so that it can interrupt the circuit current through the electrical apparatus, while at the same time a PTC component is disposed in parallel to the bimetal component. By such an arrangement, when the bimetal component activates, the current flowing through it is diverted to the PTC component; the PTC component generates a Joule heat by the current and this heat is transmitted to the bimetal component so that the activating state of the bimetal component can be maintained.

A protection device is known which is configured so that a movable contact which operates to open a circuit by the activation of the bimetal component is disposed in the electrical circuit and the PTC component is disposed in parallel to the bimetal component as described above. Such a protection device is disclosed, for example, in Patent Document 1 shown below. In such a protection device, a PTC component, a bimetal component and an arm are disposed within a space provided in a resin base having a terminal; a resin cover which is previously provided with an upper plate is disposed on the resin base, and the resin base and the resin cover in this state are bonded to be integral with an adhesive or by ultrasonic fusion.

### PRIOR ART DOCUMENT

### Patent Document

Patent Document 1: Japanese Patent Publication No. 2005-203277

### SUMMARY OF THE INVENTION

### Problem to be Solved by the Invention

The conventional protection device as described above has a relatively low flexibility of connection, for example a direction of connecting to a lead or other electrical elements is limited, since a first terminal which is a connection site with the lead or the other electrical elements and a portion of an arm which functions as a second terminal extend in opposite directions to each other from both ends of the protection device. In addition, since the bimetal component is enclosed with a resin, sensitivity to the abnormal heat generation occurring outside is not necessarily sufficient.

As another problem, in the conventional protection device described above, since a contact between the first terminal and the arm is a mechanical contact, there is a possibility that an instantaneous interruption occurs by an impact or a vibration. Therefore, the conventional protection device is not necessarily suitable for apparatuses which are easily subjected to the impact or the vibration, for example a mobile device such as a mobile phone, a tablet type personal computer, or the like.

### Means to Solve the Problem

As a result of intensive studies by the inventors of the present invention to solve the problem described above, it has been found that by electrically connecting the first terminal, the arm and the upper plate in series, exposing a portion of the upper plate from the resin cover, and using the exposed portion as the second terminal, flexibility of connecting to the lead or the other electrical elements is improved. In addition, it has been found that in a normal state, heat generated inside the protection device can be effectively ejected from the exposed portion to the outside, so that a holding current of the protection device can be increased. Furthermore, it has been found that in an abnormal state, the sensitivity to the abnormal heat generation occurring outside can be increased.

Furthermore, the inventors of the present invention have found, as a preferable embodiment, that by setting a contact pressure at a contact between the first terminal and the arm to not less than a prescribed pressure, the instantaneous interruption can be suppressed.

In one aspect, the present invention provides a protection device comprising a resin base, a first terminal, a PTC component, a bimetal component, an arm, an upper plate and a resin cover, wherein the first terminal, the PTC component, the bimetal component, the arm and the upper plate are superposed in the above-mentioned order within a resin housing defined by the resin base and the resin cover, a portion of the upper plate is exposed at a portion of the resin cover, and the exposed portion functions as a second terminal, the first terminal, the arm and the upper plate are electrically connected in series in the above-mentioned order, and in an abnormal state where the bimetal component activates, the first terminal and the arm are configured to be electrically cut off while the first terminal, the PTC component, the bimetal component, the arm and the upper plate are configured to be electrically connected in series in the above-mentioned order.

In a preferably embodiment, the present invention provides a protection device wherein the contact pressure at the contact between the first terminal and the arm is 30 g or more in the protection device described above.

In another aspect of the present invention, the present invention provides an electrical apparatus comprising the protection device described above.

### Effect of the Invention

According to the present invention, in the protection device comprising the resin base, the first terminal, the PTC component, the bimetal component, the arm, an upper plate and the resin cover, by exposing a portion of the upper plate from the resin cover and using the exposed portion as a second terminal, it becomes possible to connect to a lead in any direction with respect to the protection device. Furthermore, since the upper plate having a high thermal conductivity is exposed, external heat is easily transmitted to the bimetal component, thereby the sensitivity to the abnormal heat generation occurring outside is improved. In a preferable embodiment, by setting the contact pressure at the contact between the first terminal and the arm to 30 g or more, for example when the protection device is used in a mobile phone, it becomes possible to prevent an instantaneous interruption by an impact due to the dropping or the like.

### BRIEF DESCRIPTION OF THE DRAWINGS

FIG. 1 schematically shows the protection device 1 of the present invention in its perspective view.

FIG. 2 schematically shows the protection device shown in FIG. 1 in its cross-sectional view along a surface perpendicular to its upper surface including a line x-x.

FIG. 3 schematically shows the protection device shown in FIG. 1 in its exploded perspective view when the protection device is hypothetically broken down into its structural elements.

### EMBODIMENTS TO CARRY OUT THE INVENTION

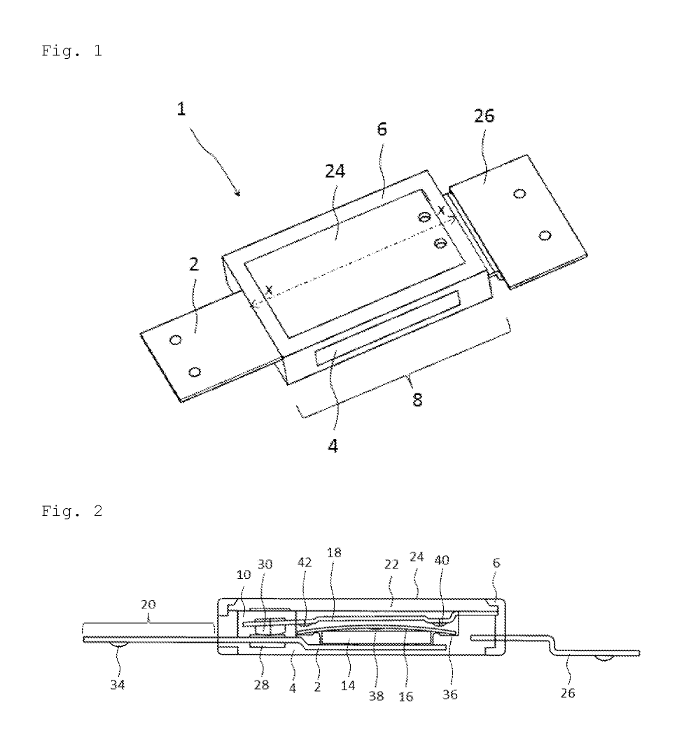

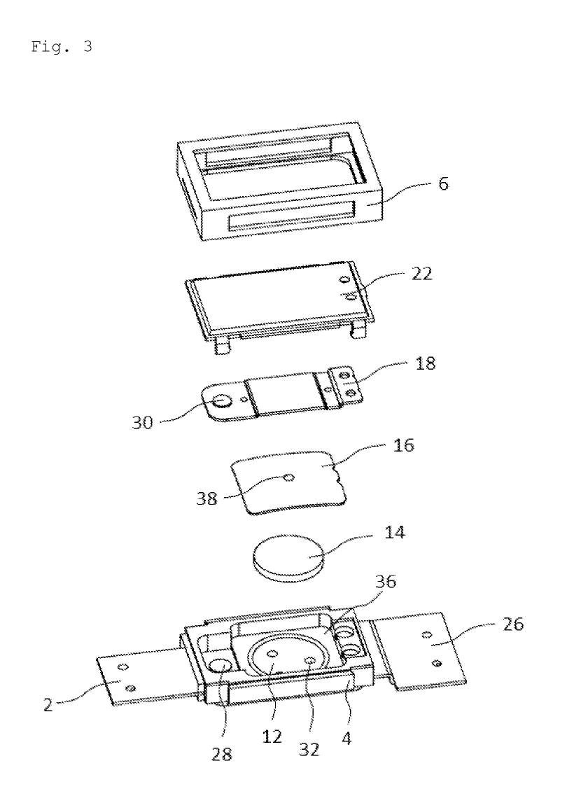

One embodiment of the present invention will be described in detail with reference to the accompanied drawings. FIG. 3 schematically shows a state in which the protection device of the present invention shown in FIG. 1 and FIG. 2 is broken down into its structural elements, and FIG. 3 schematically shows the protection device 1 of the present invention in its exploded perspective view when the protection device which is in a completed condition as a device is hypothetically broken down into its structural elements.

The protection device 1 of the present invention generally has a structure as shown in FIGS. 1-3. Specifically, the protection device 1 comprises a resin housing 8 which is defined by a resin base 4 having a first terminal 2 and a fixing member 26 and a resin cover 6. The resin base 4 has a space 10. A portion of the terminal 2 is exposed at a bottom of the resin base 4. A PTC component 14 is disposed over the exposed portion 12, a bimetal component 16 is disposed over the PTC component 14, and an arm 18 is disposed over the bimetal component 16. A portion 20 of the terminal penetrates through the resin housing 8 and extends to the outside of the housing. The space 10 including the exposed portion 12 of the terminal, the PTC component 14, the bimetal component 16 and a portion of the arm 18 is sealed with the upper plate 22. They are further covered with the resin cover 6 such that the portion 20 of the terminal protrudes from the resin housing 8 and the portion 24 of the upper plate 22 is exposed to the outside. The portion 24 (which is hereinafter also referred to as the exposed portion 24) of the upper plate 22 exposed on the resin cover 6 is a part for electrically connecting to a lead or other electrical elements, and functions as a second terminal. Furthermore, the resin base 4 has a fixing member 26 for aiding the fixing of the protection device to a substrate, and the fixing member 26 protrudes from the resin housing 8 and extends the outside of the housing. It is noted that the fixing member 26 is used in this embodiment, but it is not an essential element and may be absent.

In the protection device 1, the first terminal 2, the arm 18 and the upper plate 22 are electrically connected in series in a normal state where an excessive current or an abnormal heat generation does not occur. The bimetal component 16 is bent so as to be in an upwardly convex state (a convex state toward the arm) as illustrated, and is separated from the arm 18. In this state, a current flows through and in the order of the first terminal 2, a contact part 28 of the first terminal, a contact part 30 of the arm, the arm 18 and the upper plate 22 (or in the reverse order), and the current does not flow through the PTC component 14 and the bimetal component 16. In an abnormal state, i.e. when the excessive current occurs or when the abnormal heat generation occurs, the bimetal component 16 activates and deforms into a downwardly convex state (downwardly convex with respect to the paper sheet of FIG. 2) from the upwardly convex (upwardly convex with respect to the paper sheet of FIG. 2), as a result of which the arm 18 is pushed upwardly and the electrical connection between the contact part 30 of the arm and the contact part 28 of the first terminal is cut off. The deformed bimetal component 16 contacts the PTC component 14 and the arm 18 and becomes to be in a state of electrically connecting to them. In this state, the current flows in order of the first terminal 2, the PTC component 14, the bimetal component 16, the arm 18, and the upper plate 22 (or in the reverse order), and the PTC component 14 trips (activates) due to a Joule heat generated by this current, as a result of which the Joule heat continues to be generated. The bimetal component 16 is maintained to be in the downwardly convex state by the Joule heat, so that the opening state of the contact between the arm 18 and the first terminal 2 can be maintained. In this stage, the current flowing through the circuit to be protected is substantively interrupted (however, an extremely small amount of current can flow as a leak current).

In one embodiment of the present invention, the first terminal 2, the fixing member 26 and the resin base 4 are formed to be integral together by insert molding. By using such insert molding, the adhesion between the first terminal 2 and the resin base 4 can be enhanced. The resin base 4 has the space 10, and a portion 12 of the first terminal 2 is exposed at the bottom of the space. The PTC component 14 is disposed on the exposed portion 12 of first terminal. The first terminal 2 may have a plurality of contacts 32, for example three contacts, having for example a domed shape on the exposed portion 12 so as to ensure an electrical connection with the PTC component 14 easily (see FIG. 3).

A material constituting the first terminal 2 is not particularly limited as long as it is an electrically conductive material, but it is preferably an electrically conductive metal. The first terminal 2 has the contact part 28 which contacts with the contact part 30 of the arm 18. The contact part 28 can be formed by swaging a contact element to a hole provided at a corresponding position of the first terminal 2 such that the hole penetrates through the first terminal. The term “swaging” as used herein means that into a hole provided to a certain member (for example, a plate for the first terminal) through the member, another member (for example, the contact element) having a diameter comparable to that of the hole and a thickness (or height) larger than that of the hole is fitted, and then portions which project upwardly and downwardly from the hole are squashed to fix said another member to the certain member. It is noted that the contact element is not necessarily in a circular cylindrical form, and it may be in a rectangular cylindrical form or the like. By forming such a contact part in the first terminal 2, the contact part can have a larger thermal capacity, as a result of which, even when a relatively larger amount of current flows through the protection device, rapid rise of a temperature of the contact parts can be prevented so that the holding current of the protection device can be increased.

A metal constituting the contact element is not particularly limited, but is preferably a metal having a larger thermal capacity, for example, a silver-nickel alloy, a silver-copper alloy, AgCdO, AgSnO₂, AgZnO, AgSnOInO, AgCu, a copper-tungsten alloy or the like. A 90% silver-10% nickel alloy is preferable in view that a fine design of a form of the contact part, in particular its thickness can be performed due to its lower hardness and a thermal capacity is larger.

The first terminal 2 may preferably have a rib on at least its portion of the first terminal, for example, around the exposed portion 12. The term “rib” as used herein means an element or a structure for enhancing a strength of a member on which the rib is provided. For example, it includes a reinforcement element having a line shape, a rod shape or a strip shape which is provided on the surface of the member and a structure in which a portion of the surface of the member is deformed to a convex shape or a concave shape. By forming such a rib, a stiffness of the protection device, in particular the strength against an external pressure from a surface of the back side of the protection device (i.e. a surface of the first terminal side) can be enhanced.

As mentioned above, the portion 20 of the first terminal penetrates through a side wall of the resin housing 8 and extends outwardly. This portion 20 of the first terminal is intended for electrically connecting the protection device 1 of the present invention to a prescribed electrical element, and therefore, provides an essential function of the first terminal. As illustrated, a contact 34 may be provided on the portion 20 of the first terminal.

Preferably, the resin base 6 is formed of a thermally resistant resin. By using such a resin, deformation of the protection device can be prevented even when it is subjected to a high temperature environment such as an environment within a reflow furnace, as a result of which surface mounting of the protection device can be performed.

Examples of the thermal resistant resin described above include, for example, an LCP (Liquid Crystal Polymer) resin, a polyamide resin, a PPS (Poly Phenylene Sulfide) resin and the like.

The protection device of the present invention may have the fixing member 26. The position of the fixing member is not limited to the illustrated example, and the fixing member may be provided at any position where the fixing member can be located. A plurality of fixing members, for example, 2, 3, 4 or more fixing members may exist. By providing such a fixing member, it becomes possible to install the protection device on a substrate more surely and more stably.

In the protection device of the present invention, the PTC component 14 is disposed on the exposed portion 12 of the first terminal. As a result, the first terminal 2 and the PTC component 14 are electrically connected via, for example the contact 32.

As the PTC component described above, either a ceramic PTC component or a polymer PTC component may be used, but it is preferable to use the polymer PTC component. The polymer PTC component is advantageous in comparison with the ceramic PTC component in that a resistance of the component itself is lower and a self-destruction is unlikely to occur even when its temperature reaches a predetermined temperature. Additionally, as to the polymer PTC component, a voltage required to maintain a tripping state is lower in comparison with the ceramic PTC component, and therefore, the polymer PTC component can maintain the tripping state even when a circuit voltage is low. As the result of this, the polymer PTC component is advantageous in that the contact can be maintained in an open state (latch state), so that chattering (i.e. a phenomenon wherein opening and closing between the contacts are repeated) can be prevented. Furthermore, when the holding current values of the ceramic PTC component and the polymer PTC component are the same, the polymer PTC component is preferable in that it has a smaller size and has a lower resistance relative to the ceramic PTC component.

Generally, the above mentioned polymer PTC component comprises a laminar PTC element which is formed by extruding an electrically conductive composition containing a polymer (for example, a polyethylene, a polyvinylidene fluoride, or the like) in which an electrically conductive filler (for example, carbon black, nickel alloy, or the like) is dispersed, and electrodes (for example, metal foils) which are disposed on both sides of the PTC element.

A size and a shape of the polymer PTC component are not particularly limited. In the protection device of the present invention, for example, the PTC component which is of a disk shape having a diameter of 2.0 mm or less, and a thickness of 0.20 mm or less can be used.

When the polymer PTC component is used as the PTC component in the protection device of the present invention, its resistance value is preferably 0.8-10Ω, and more preferably 4.5-10Ω. For example, by setting the resistance of the polymer PTC component to 0.8Ω or more, the tripping state can be maintained with 3 V. By setting the resistance of the polymer PTC component to 4.5Ω or more, the leak current can be 0.2 A or less in the tripping state at 3 V. By setting the resistance of the polymer PTC component 10Ω or less, a variation in the resistance in producing of the polymer PTC component can easily be reduced.

It is noted that the resistance value of the polymer PTC component in the present specification means a resistance value (measured by four-terminal method, applied current of a measurement range of a resistance measurement equipment: 100 mA) which is calculated from an applied voltage and a current value which is measured when a voltage of 6.5 mV (direct current) is applied at 25° C. between both electrodes of a PTC component which is produced by the pressure-bonding of the electrodes (preferably, nickel foils) on both sides of a PTC element obtained by the extrusion of an electrically conductive composition comprising a polymer. It is noted that since a resistance value of the electrodes is negligibly small in comparison with the resistance value of the PTC element, the resistance value of the PTC component is substantially equal to the resistance value of the PTC element.

In the protection device of the present invention, the bimetal component 16 is disposed over the PTC component 14. The bimetal component 16 is supported by a step part 36 provided within the space 10 or a shoulder part of the PTC component 14. Preferably, the bimetal component 16 is supported by the shoulder part of the PTC component and is separated from the step part 36. By applying such an arrangement, when a temperature of the protection device is lower than its usual operating temperature, for example the temperature of the device is a room temperature to −40° C., though a curvature of the bimetal component becomes higher and its height (a height from an edge to a top of the bimetal component) becomes larger, it is suppressed that the top of the bimetal component closes to the arm until the edge of the bimetal component reaches the step part 36. Preferably, the step part 36 has a convex part along the edge of the step part as illustrated in order to suppress a deformation of the bimetal component 16 at a lower temperature.

The bimetal component 16 is not particularly limited as long as it deforms at a temperature to be determined to be in an abnormal state, and any known one can be used. In a normal state, the bimetal component 16 may be or may not be electrically connected to the PTC component 14, but in an abnormal state, it is electrically connected thereto.

The bimetal component 16 preferably has its main surface area as large as provided that the space 10 of the resin base permits. By having a larger the main surface area, a variation of an activating temperature of the bimetal component can be reduced, and the force for pushing the arm 18 upwardly is increased when it deforms in the abnormal state. Thereby, it becomes possible to increase the contact pressure between the first terminal and the arm, as a result of which the instantaneous interruption can be more suppressed.

The number of the bimetal component 16 is one in the illustrated embodiment, but it may be 2 or more. By using a plurality of the bimetal components, a force for pushing the arm 18 upwardly is increased at the time of the abnormal state. When two or more bimetal components are used, they may be the same bimetal components or the different bimetal components. Specifically, the bimetal components having different activating temperatures are used. For example, the bimetal components are used such that the activating temperature of the upper bimetal component are higher than the activating temperature of the lower bimetal component; the bimetal components having different thicknesses and/or different sizes are used; the bimetal components having contact surfaces of the same curvatures are used; or the bimetal components having no a central protrusion may be used except for the lowermost bimetal component. As mentioned above, by combining various bimetal components, the force for pushing the arm upwardly can be adjusted when the bimetal component deforms into the downwardly convex form.

A thickness of the bimetal component 16 is preferably 0.06 mm or more, more preferably 0.07 mm or more when one piece of the bimetal component is used. The thickness is preferably 0.058 mm or more when two pieces of the bimetal components are used. By using the bimetal component having such a thickness, even when the contact pressure between the first terminal 2 and the arm 18 is higher, the sufficient force for pushing the arm 18 upwardly in an abnormal state can be obtained. When three or more pieces of the bimetal components are used, the bimetal component having a less thickness may be used. The thickness of the bimetal component 16 is not particularly limited, but it is for example 0.2 mm or less, preferably 0.1 mm or more. By setting the thickness of the bimetal component 16 to 0.2 mm or less, the protection device can be further compact.

Preferably, the bimetal component 16 may have a protrusion, for example, a dome-shaped convex part 38 near the center of the lower surface of the component (the surface on the PTC component side). When the bimetal component 16 activates and deforms into the downwardly convex state from the upwardly convex state, this protrusion comes in contact with the PTC component 14. Since the arm 18 is pushed upwardly by an extra distance corresponding to the height of the protrusion, the arm is sufficiently pushed up even when the degree of curvature of the bimetal component 16 itself is smaller, and therefore, the electrical connection at the contact between the arm and the first terminal can more surely be cut off.

In the protection device of the present invention, the arm 18 is positioned over the bimetal component 16 and is electrically connected to the upper plate 22 at the end opposite to the contact part 30. A method for connecting the arm 18 and the upper plate 22 includes, but is not limited to, soldering, welding, or the like, and it is preferable to use a laser welding. Alternatively, the arm 18 and the upper plate 22 may be originally formed to be integral.

The arm 18 has the contact part 30, and it is formed into a bent shape such that the contact part 30 is positioned lower a little with respect to a horizontal direction (a direction along which the bottom surface of the resin base extends) as illustrated. This contact part 30 contacts the contact part 28 of the first terminal in the normal state, while the bimetal component 16 deforms in the abnormal state thereby pushing the arm 18 upwardly, as a result of which thus mentioned contacting state is dissolved.

Similarly to the contact part 28 of the first terminal, the contact part 30 can be formed by swaging a contact element to a hole provided to a corresponding position of the arm 18. By forming such a contact part in the arm 18, the contact part can have a larger thermal capacity, as a result of which a rapid rise of temperature of the contact parts can be prevented even when a relatively larger current flows through the protection device, so that the holding current of the protection device can be increased. It is noted that though it is sufficient that either the contact part 28 of the first terminal or the contact part 30 of the arm 18 is formed by swaging the contact element through the first terminal or the arm, it is preferable that both contact parts are formed by swaging the contact elements.

A metal constituting the contact mater element described above is the same as that constituting the contact part 28 of the first terminal.

The arm 18 may have contacts 40, 42 at positions where the bimetal component deforms into a downwardly convex form and contacts the arm so as to further ensure an electrical connection between the arm and the bimetal component when the bimetal component deforms in an abnormal state.

Preferably, as illustrated, the arm 18 has a concave shape toward the upper plate in the space 10. That is, as illustrated in FIG. 2, the arm 18 has such a shape that its portion positioned over the bimetal component bents toward the upper plate. By applying such a shape, in a normal state, a distance of the arm from the bimetal component 16 can be larger, and an insulation state is more surely ensured.

A material constituting the arm 18 is not limited as long as it is an electrically conductive material, but is preferably a copper alloy including phosphor bronze or beryllium bronze, Ni or thus mentioned materials which are surface-treated (plated with gold, silver, Ni or the like).

The arm 18 has a width of preferably 1.0 mm or more, more preferably 1.5 mm or more. By setting the width of the arm to 1.0 mm or more, the contact pressure between the contact part 28 of the first terminal and the contact part of the arm can be increased, the instantaneous interruption by an impact, a vibration or the like can be suppressed. The width of the arm 18 is not particularly limited, but is for example 3.0 mm or less, preferably 2.5 mm or less. By setting the width of the arm 18 to 3.0 mm or less, the protection device can be more compact.

The arm 18 has a length of preferably 3.0-5.0 mm, more preferably 3.5-4.5 mm. By setting the length to within those ranges, the protection device can be more compact. In addition, depending on a moving distance of the movable contact and the upwardly pushing force of the bimetal component upon activating of the bimetal component, by setting the length to 5.0 mm or less such that the length becomes shorter, an influence of vibration or the like can be decreased, and thereby the instantaneous interruption can be further suppressed. By setting the length to 3.0 mm or more, the moving distance of the movable contact becomes larger, and thereby the interruption is more surely ensured.

Preferably, the arm used in the protection device of the present invention has a width of 1.0-3.0 mm, and a length of 3.0-5.0 mm.

The contact pressure between the contact part 28 of the first terminal and the contact part 30 of the arm is not particularly limited, but is preferably 20 g or more, more preferably 30 g or more. By setting the contact pressure as mentioned above, the instantaneous interruption by an impact due to the dropping or the like in an electrical apparatus comprising the protection device can be suppressed. The contact pressure is not particularly limited, but is for example 60 g or less, preferably 40 g or less. By setting the contact pressure to 60 g or less, it becomes easy to activate the moving contact and design flexibility of the bimetal component which activates the movable contact is increased. The “contact pressure” means a pressure of contacting between the contact part 28 of the first terminal and the contact part 30 of the arm, and it means a pressure with which the contact part 28 of the first terminal pushes the contact part 30 of the arm. The pressure of contacting can be measured by a common instrument for measuring the pressure of contacting, for example, Push-Pull Gauge RX-1 (AIKOH).

In the protection device of the present invention, the upper plate 22 is disposed over the arm in the space 10, and is electrically connected to the arm 18 as described above. Furthermore, the portion 24 of the upper plate is exposed to the outside on the resin cover 6. Since the upper plate 22 is exposed to the outside, it has a function to efficiently transmit the heat to the inside of the protection device when the abnormal heat generation occurs outside. By this function, the protection device of the present invention can readily detect the abnormal heat generation, activate the bimetal 16, and interrupt the current. In addition, in a normal state, the protection device of the present invention can efficiently dissipate a heat generated within the protection device, in particular at the contact, to the outside of the protection device, so that the holding current can be increased.

The exposed area of the upper plate is preferably as large as possible. For example, the exposed area of the upper plate is preferably 50% or more, more preferably 60%, further preferably 70% of the area of the upper surface of the protection device. In view of fixing the upper plate more surely, the exposed area of the upper plate is 98% or less, for example preferably 90% or less or 80% or less of the area of the upper surface of the protection device.

The portion 24 of the upper plate (the exposed portion 24) is for electrically connecting to a lead or other electrical elements, that is, it functions as the second terminal. Since there is no other element which may be an obstacle on a plane including a exposed surface of the exposed portion 24, a direction of the connecting of the lead or the other elements is not limited. In addition, by enlarging the area of the exposed surface, for example by setting the area to 40-80%, preferably 50-70% of the upper surface of the protection device (a surface including the exposed surface of the upper plate), the connecting becomes easy, in particular the connecting to a plurality of the leads or the electrical elements becomes easy.

In the protection device of the present invention, it is possible to weld the lead or the other elements directly to the exposed portion 24 of the upper plate.

It is preferable that the upper plate 22 has a thickness of preferably 0.1 mm or more, more preferably 0.2 mm or more in particular at its exposed portion 24. By applying such a thickness, a resistance against a welding load when the lead or the other elements is welded directly to the exposed portion 24 can be increased. A thickness of the upper plate 22 is not particularly limited, but is for example 1.0 mm or less, preferably 0.5 mm or less. By setting the thickness of the upper plate 22 to 1.0 mm or less, the protection device can be more minimized.

It is preferable that the exposed surface 24 is plated with a metal which is unsusceptible to oxidation. By plating with such a metal, an increase of resistance due to an oxidation of the exposed surface can be prevented when the protection device is heat-treated in a reflow furnace. From the similar view, it is preferable that the portion 20 of the first terminal is also plated with the metal which is unsusceptible to oxidation.

Examples of the metal which is unsusceptible to oxidation include, but are not limited to, for example, gold, platinum, silver, copper, and the like, and in particular gold is preferable.

In the protection device of the present invention, the resin cover 6 is disposed such that it covers the upper plate 22 other than the exposed portion 24. The resin cover 6 defines the resin housing 8 together with the resin base 4. The resin cover 6 and the resin base 4 can be bonded, for example, by using an adhesive, an ultrasonic welding, a laser welding or the like.

A resin constituting the resin cover 6 may be, but not particularly limited to, the same resin as or the different resin from the resin constituting the resin base 4. It is preferable that it is a thermal resistant resin. By using a resin compatible to the resin constituting the resin base 4, preferably the same resin as that for the resin base, the bonding between the resin base 4 and the resin cover 6 can be further ensured.

The resin cover 6 may be formed around an assembly prepared by the resin base 4 having the first terminal 2 and the fixing member 26 which is present if necessary, the PTC component 14, the bimetal component 16, the arm 18 and the upper plate 22 are assembled as illustrated by putting thus assembled assembly in a prescribed mold, and injection-molding the assemble with a resin, i.e., insert-molding while the portion 20 of the first terminal extends outwardly through one side of the mold and the fixing member 26 extends outwardly through from the other side of the mold.

When the insert-molding is performed, it is preferable that the upper plate 22 substantially closes the space 10 as illustrated which space is defined by the resin base 4. It is noted that the term “substantially close” means that, when the resin cover 6 is formed by the insert-molding in producing the protection device of the present invention, the molten resin used in molding cannot penetrate into the space 10. In other words, it means that, in the protection device of the present invention, the resin used for molding have not penetrated into the space 10 when the resin cover 6 is formed by the insert-molding.

The protection device of the present invention can be miniaturized, for example, because of having no resin covering the upper plate. In particular, a thickness of the protection device of the present invention can have, for example 1.5 mm or less, more preferably 1.0 mm or less of a size. Preferably, the protection device of the present invention has a width of 2.0-4.5 mm and a length of 4.5-15.0 mm.

### INDUSTRIAL APPLICABILITY

The protection device of the present invention can be suitably used as a protection device in a lithium ion battery cell in a mobile phone, a tablet apparatus or the like.

### EXPLANATION OF THE REFERENCE NUMERALS

1—protection device;
2—first terminal;
4—resin base;
6—resin cover;
8—resin housing;
10—space;
12—exposed portion;
14—PTC component;
16—bimetal component;
18—arm;
20—portion of first terminal;
22—upper plate;
24—portion of upper plate (exposed portion);
26—fixing member;
28—contact part of first terminal;
30—contact part of arm;
32—contact;
34—contact;
36—step part;
38—convex part;
40,42—contact

1. A protection device comprising a resin base, a first terminal, a PTC component, a bimetal component, an arm, an upper plate and a resin cover, wherein
the first terminal, the PTC component, the bimetal component, the arm and the upper plate are superposed in the above-mentioned order within a resin housing defined by the resin base and the resin cover,
a portion of the upper plate is exposed at a portion of the resin cover, and the exposed portion functions as a second terminal,
the first terminal, the arm and the upper plate are electrically connected in series in the above-mentioned order, and
in an abnormal state where the bimetal component activates, the first terminal and the arm are configured to be electrically cut off while the first terminal, the PTC component, the bimetal component, the arm and the upper plate are configured to be electrically connected in series in the above-mentioned order.

2. The protection device according to claim 1 wherein an area of the exposed portion of the upper plate occupies 50-98% of an area of the upper surface of the protection device.

3. The protection device according to claim 1 wherein a thickness of the exposed portion of the upper plate is more than 0.1 mm.

4. The protection device according to claim 1 wherein a thickness of the bimetal component is 0.06 mm or more.

5. The protection device according to claim 1 wherein two or more bimetal components are used in a stacked state.

6. The protection device according to claim 1 wherein the arm dents toward the upper plate in the resin housing.

7. The protection device according to claim 1 wherein a width of the arm is 1.0 mm or more.

8. The protection device according to claim 1 wherein a contact pressure at a contact between the first terminal and the arm is 20 g or more.

9. The protection device according to claim 1 wherein the arm and the upper plate are welded.

10. The protection device according to claim 1 wherein each of the resin base and the resin cover is formed from a thermal resistant resin.

11. The protection device according to claim 1 wherein the exposed portions of the first terminal and/or the upper plate are plated with a metal unsusceptible to oxidation.

12. The protection device according to claim 11 wherein the metal unsusceptible to oxidation is gold.

13. The protection device according to claim 1 further comprising a member for fixing.

14. (canceled)
